(19) United States
(12) Patent Application Publication
(10) Pub. No.: US 2024/0364202 A1
(43) Pub. Date: Oct. 31, 2024

(54) INNER-LOOP CONTROL FOR MULTI-LEVEL CONVERTER

(71) Applicant: Cirrus Logic International Semiconductor Ltd., Edinburgh (GB)

(72) Inventors: Jason W. LAWRENCE, Austin, TX (US); Hasnain AKRAM, Austin, TX (US); Graeme G. MACKAY, Austin, TX (US); Ivan PERRY, Penicuik (GB)

(73) Assignee: Cirrus Logic International Semiconductor Ltd., Edinburgh (GB)

(21) Appl. No.: 18/308,902

(22) Filed: Apr. 28, 2023

(51) Int. Cl. H02M 1/00; H02M 3/04

(52) U.S. Cl. CPC H02M 1/0025; H02M 1/0009; H02M 3/04

(57) ABSTRACT

A control circuit for generating a control parameter that defines a state sequence of a power converter may include a loop filter configured to, based on an error signal between a reference current signal and a feedback current measurement signal, correct for unmodeled errors in the feedback current measurement signal to generate the control parameter. The control circuit may also include a first feedforward block configured to generate a first offset to the control parameter based on a slew rate of the reference current signal.

### FIELD OF DISCLOSURE

The present disclosure relates in general to circuits for electronic devices, including without limitation personal audio devices such as wireless telephones and media players, and more specifically, closed-loop control of power converters, including multi-level power converters.

### BACKGROUND

Personal audio devices, including wireless telephones, such as mobile/cellular telephones, cordless telephones, mp3 players, and other consumer audio devices, are in widespread use. Such personal audio devices may include circuitry for driving a pair of headphones, one or more speakers, haptic actuators, camera stabilization motors, and/or other load. Such circuitry often includes a driver including a power amplifier for driving an output signal to such loads. Oftentimes, a power converter may be used to provide a supply voltage to a power amplifier in order to amplify a signal driven to speakers, headphones, other transducers, or other loads. A switching power converter is a type of electronic circuit that converts a source of power from one direct current (DC) voltage level to another DC voltage level. Examples of such switching DC-DC converters include but are not limited to a boost converter, a buck converter, a buck-boost converter, an inverting buck-boost converter, and other types of switching DC-DC converters. Thus, using a power converter, a DC voltage such as that provided by a battery may be converted to another DC voltage used to power the power amplifier. A power converter may be used to provide supply voltage rails to one or more components in a device. A power converter may also be used in other applications besides driving audio transducers, such as driving haptic actuators or other electrical or electronic loads. Further, a power converter may also be used in charging a battery from a source of electrical energy (e.g., an AC-to-DC adapter).

FIG. 1 illustrates selected components of an example circuit 100 for driving a load 120, as is known in the art. As shown in FIG. 1, a modulator 110 may receive a control parameter D (e.g., which may be a digital signal indicative of a desired output voltage V_{OUT} to be driven to load 120), and based on such control parameter, generate switching control signals for controlling switches of an analog power stage, such as a power converter 101, for example.

One type of power converter often used in electronic circuits is a 3-level power converter. FIG. 1 depicts power converter 101 as a 3-level power converter, as is known in the art. As shown in FIG. 1, power converter 101 may receive an input voltage V_{IN} and have an output configured to generate an output voltage V_{OUT} based on switching signals received from modulator 110. Further, power converter 101 may include a switching node having a voltage L_{X}. Power converter 101 may include a power inductor 102 coupled between the switching node and the output. Moreover, power converter 101 may include a flying capacitor 104 having a first capacitor terminal and a second capacitor terminal. In addition, power converter 101 may include a plurality of switches 106a, 106b, 106c, 106d, and 106e, wherein switch 106a is coupled between the input and the first capacitor terminal, switch 106b is coupled between the first capacitor terminal and the switching node, switch 106c is coupled between the second capacitor terminal and the switching node, switch 106d is coupled between the second capacitor terminal and a ground voltage, and switch 106e is coupled between the second capacitor terminal and the input. In operation, switches 106a, 106b, 106c, 106d, and 106e may be controlled by modulator 110 to regulate output voltage V_{OUT} to a desired target voltage.

In general, power converter 101 may be operated in a plurality of switching states, including a “VS” state as shown in FIG. 2A, a “VCS” state as shown in FIG. 2B, a “GCS” state as shown in FIG. 2C, and a “GS” state as shown in FIG. 2D. As shown in FIG. 3, an average voltage L_{X} on the switching node of power converter 101 may be a function of control parameter D, which may control a percentage of time power converter 101 operates in each of its states, as shown in FIG. 4.

It may be desirable that inductor current I_{L} be accurately controlled with high-bandwidth in the presence of a possibly time-varying input voltage V_{IN}, output voltage V_{OUT}, and output load 120. However, existing systems often provide for proportional-integral-dervative (PID) control of control parameter D based on measured current I_{L}, which may not provide for such high-bandwidth control due to the latency inherent in a feedback loop.

### SUMMARY

In accordance with the teachings of the present disclosure, one or more disadvantages and problems associated with existing topologies for hybrid 3-level buck-boost converters may be reduced or eliminated.

In accordance with embodiments of the present disclosure, a control circuit for generating a control parameter that defines a state sequence of a power converter may include a loop filter configured to, based on an error signal between a reference current signal and a feedback current measurement signal, correct for unmodeled errors in the feedback current measurement signal to generate the control parameter. The control circuit may also include a first feedforward block configured to generate a first offset to the control parameter based on a slew rate of the reference current signal.

In accordance with these and other embodiments of the present disclosure, a method for generating a control parameter that defines a state sequence of a power converter may include, based on an error signal between a reference current signal and a feedback current measurement signal, correcting with a loop filter for unmodeled errors in the feedback current measurement signal to generate the control parameter. The method may also include generating with a first feedforward block a first offset to the control parameter based on a slew rate of the reference current signal.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a circuit diagram of selected components of an example circuit for driving a load using a 3-level power converter, as is known in the art;

FIGS. 2A-2D illustrate various switch states of the 3-level power converter shown in FIG. 1, as is known in the art;

FIG. 3 illustrates a graph of an average voltage on a switching node of the 3-level power converter shown in FIG. 1 as a function of a control parameter received at an input of the modulator shown in FIG. 1, as is known in the art;

FIG. 4 illustrates a graph of relative periods of time that the 3-level power converter shown in FIG. 1 operate in various switching states as a function of a control parameter received at an input of the modulator shown in FIG. 1, as is known in the art;

FIG. 5 illustrates a block diagram of selected components of an example system for driving a load using a power converter, in accordance with embodiments of the present disclosure;

FIG. 6 illustrates a block diagram of an example algorithm performed by a trajectory generator, in accordance with embodiments of the present disclosure;

FIG. 7 illustrates a block diagram of an example algorithm performed by a feedforward correction block, in accordance with embodiments of the present disclosure; and

FIG. 8 illustrates a block diagram of an example algorithm performed by a feedforward block, in accordance with embodiments of the present disclosure.

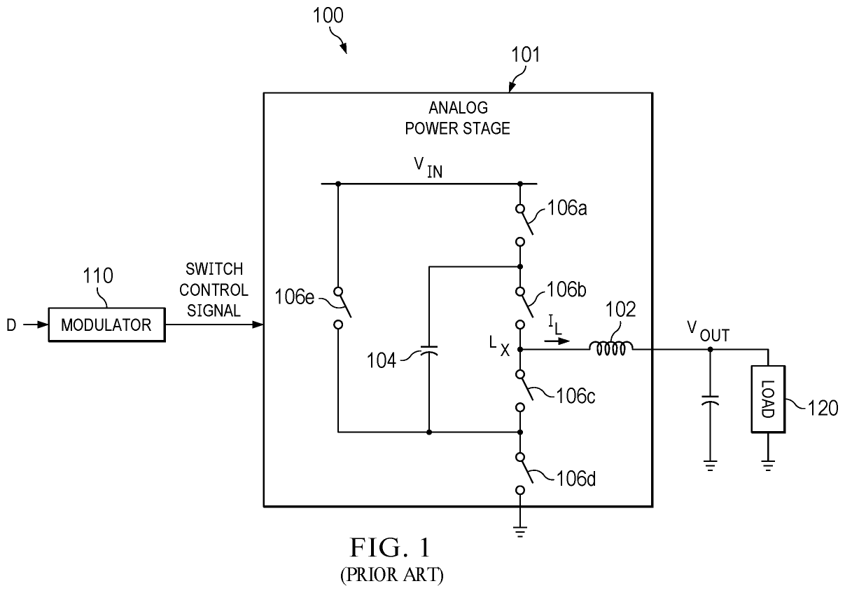

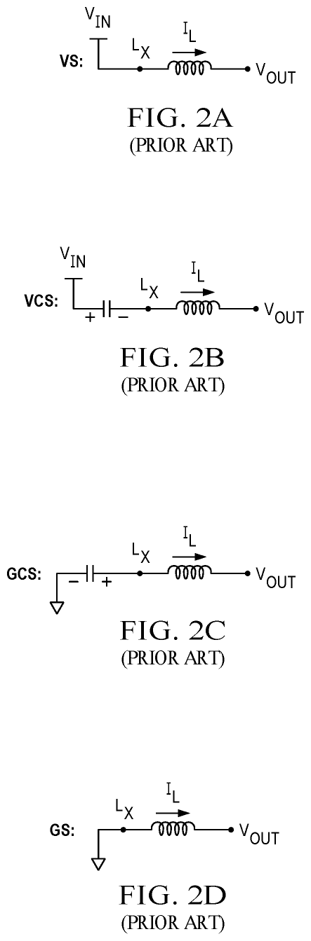

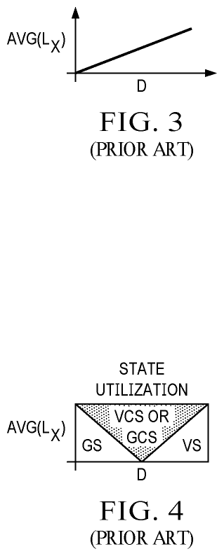

### DETAILED DESCRIPTION

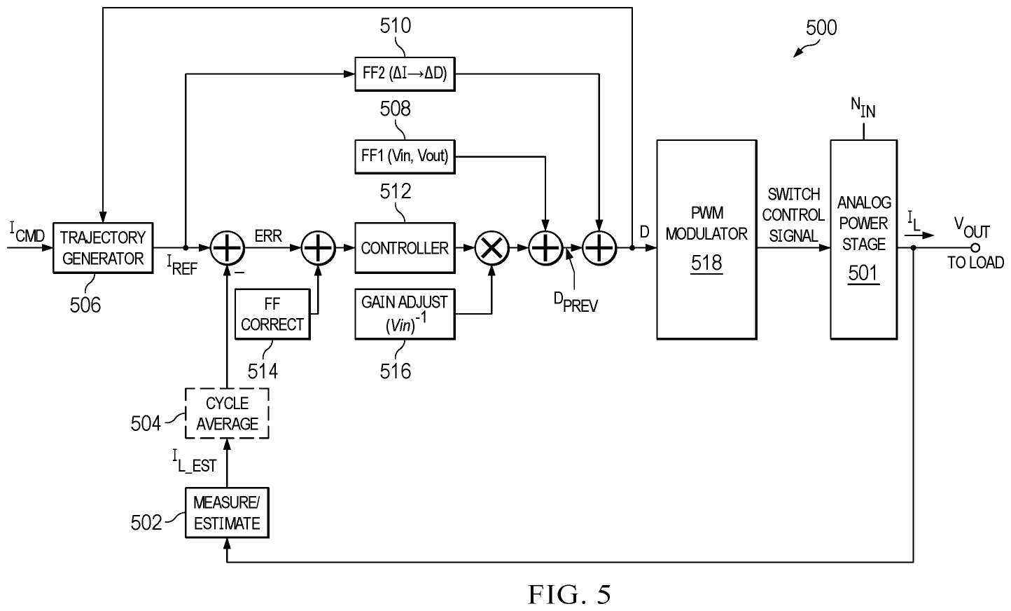

FIG. 5 illustrates a block diagram of selected components of an example system 500 for driving a load using a switched analog power stage 501, in accordance with embodiments of the present disclosure. As shown in FIG. 5, system 500 may include analog power stage 501, a measurement/estimation block 502, a cycle average block 504 (dashed lines indicating that cycle average block 504 may be optional), a trajectory generator 506, a first feedforward (FF1) block 508, a second feedforward (FF2) block 510, a loop controller 512, a feedforward (FF) correction block 514, a gain adjustment block 516, and a pulse-width modulation (PWM) modulator 518.

Analog power stage 501 may comprise any suitable system, device, or apparatus configured to drive a current I_{L} and a voltage V_{OUT} from a supply voltage V_{IN} based on switch control signals provided from PWM modulator 518. In some embodiments, analog power stage 501 may comprise an inductive- and/or capacitive-based power converter. In particular embodiments, analog power stage 501 may comprise a multi-level power converter identical or similar to that discussed in the Background section of this application.

Measurement/estimation block 502 may comprise any suitable system, device, or apparatus configured to measure current I_{L} and generate an estimated current I_{L} EST based thereon. Measurement/estimation block 502 may comprise any suitable combination of analog components (e.g., analog-to-digital converter, comparator, etc.) and/or digital components (e.g., estimator, interpolator, etc.). If present, cycle average block 504 may comprise any suitable filter configured to average estimated current I_{L} EST over a single switching cycle, to filter out any switching ripple.

The output of cycle average block 504 (or if cycle average block 504 is not present, the output of measurement/estimation block 502), may be subtracted from a reference current signal I_{REF} generated by trajectory generator 506 in order to generate error signal ERR. Trajectory generator 506 may receive as its input a target current signal I_{CMD} and condition target current signal I_{CMD} to prevent saturation of control parameter D that may occur when target current signal I_{CMD} comprises a step of high slew rate, and may provide signal headroom for controller 512 and various correction factors and adjustments to the signal path that may be added by feedforward blocks in system 500. Accordingly, trajectory generator 506 may speed up the response of system 500 by spreading out large steps in target current signal I_{CMD} over several cycles. As mentioned, trajectory generator 506 may also prevent saturation of controller 512 which may enable larger gains in controller 512, further maximizing bandwidth.

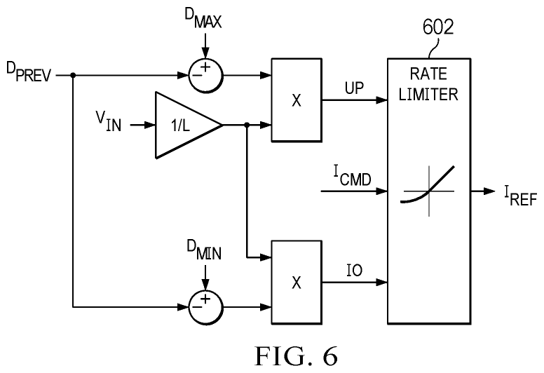

FIG. 6 illustrates a block diagram of an example algorithm performed by trajectory generator 506, in accordance with embodiments of the present disclosure. As shown in FIG. 6, a rate limiter 602 may insert a ramp in place of target current signal I_{CMD} to generate reference current signal I_{REF} whenever the slope of target current signal I_{CMD} exceeds a positive (up) or negative (lo) limit. Positive limit up may be calculated as:

$$u p = \frac{{V}_{IN}}{L} ( {D}_{max} - {D}_{prev} )$$

and negative limit lo may be calculated as:

$$l o = \frac{{V}_{IN}}{L} ( {D}_{prev} - {D}_{min} )$$

wherein L is an inductance of a power inductor integral to analog power stage 501, Dₚᵣₑᵥ is the previous value of controller 512 as adjusted by gain adjust block 516 and first feedforward block 508 as shown in FIG. 5, and Dₘᵢₙ and Dₘₐₓ may be the minimum and maximum values, respectively, for control parameter D within system 500. In both of the foregoing equations, previous values of control parameter D relative to the system limits may be used to predict how much remaining headroom is available for second feedforward block 510 to prevent saturation. Thus, trajectory generator 506 may use this headroom, along with supply voltage V_{IN} and inductance L, to set maximum and minimum achievable slew rates for current I_{L}.

Feedforward correction block 514 may comprise any suitable system, device, or apparatus configured to generate a feedforward correction signal that compensates for an expected error introduced by second feedforward block 510 discussed above. Such feedforward correction signal may subtracted from error signal ERR, and may minimize overcorrection from controller 512 and/or minimize signal ripple. In particular, feedforward correction block 514 may predict a two-cycle ramp response from first feedforward block 508 and generate an output signal that removes such response from error signal ERR prior to controller 512.

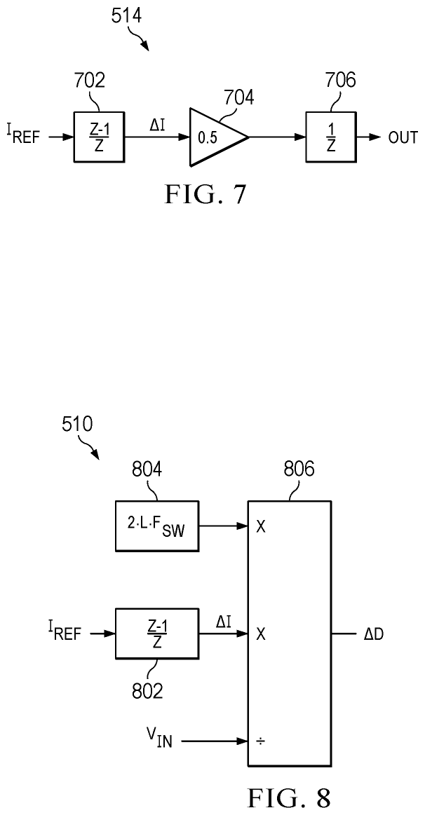

FIG. 7 illustrates a block diagram of an example algorithm performed by feedforward correction block 514, in accordance with embodiments of the present disclosure. A delay block 702 may generate change ΔI from current signal I_{REF}, and a gain block 704 may apply a gain of 0.5 to the output of delay block 702. A delay block 706 may thus generate a delayed pulse equal to one-half the amplitude of change ΔI, such delayed pulse which may be subtracted from error signal ERR before controller 512. Addition of such offset may allow inductor current I_{REF} to settle faster and may minimize erroneous output of controller 512.

Controller 512 may apply a filter response to error signal ERR as corrected by the feedforward correction signal. Controller 512 may comprise any suitable controller that may act as a loop filter within the feedback loop of system 500. For example, in some embodiments, controller 512 may implement a proportional-integral controller. Accordingly, controller 512 may use feedback to correct for unmodeled errors in the measured current.

Gain adjustment block 516 may comprise any system, device, or apparatus configured to generate a multiplicative gain adjustment factor that compensates for changes in overall system gain due to variations in supply voltage V_{IN}. Such gain adjustment factor may be multiplied by the output of controller 512. The use of gain adjustment block 516 may linearize the feedback path of system 500 in order to enable large gains within controller 512, thus potentially maximizing system bandwidth.

First feedforward block 508 may comprise any system, device, or apparatus configured to generate an additive correction to the gain-adjusted output of controller 112 in order to maintain volt-second balance between supply voltage V_{IN} and output voltage V_{OUT} when control parameter D is in steady-state. Accordingly, first feedforward block 508 may provide a high-bandwidth path to rapidly respond to ripple on supply voltage V_{IN}.

Second feedforward block 510 may comprise any system, device, or apparatus configured to predict a change ΔD of control parameter D required to achieve a change ΔI in reference current signal I_{REF}. Such prediction may be function of change ΔI, the implied changes to other system states, the absolute value of current signal I_{REF}, and/or the instantaneous values of other system states. Accordingly, second feedforward block 510 may provide a high-bandwidth path to rapidly respond to changes in target current signal I_{CMD}, and may eliminate the need for a derivative term in the filter response of controller 512. Use of second feedforward block 510 may also minimize noise sensitivity in the feedback path of system 500.

FIG. 8 illustrates a block diagram of an example algorithm performed by second feedforward block 510, in accordance with embodiments of the present disclosure. A delay block 802 may generate change ΔI and other blocks 804 and 806 may generate a gain to be applied to change ΔI, such gain equal to

$$\frac{2 \cdot {F}_{s w} \cdot L}{{V}_{i n}} .$$

wherein F_{sw} is a switching frequency of analog power stage 501 and L is an inductance of a power inductor integral to analog power stage 501. Accordingly, as shown in FIG. 8, second feedforward block 510 may apply a response

$$Δ D = \frac{2 \cdot {F}_{s w} \cdot L}{{V}_{i n}} Δ I .$$

The systems and methods described above may be expandable to a multi-phase system as the fixed frequency architecture of system 500 may enable the use of phase interleaving to cancel or otherwise minimize ripple.

The systems and methods described herein may enable direct control of control parameter D with a fixed switching frequency, which may have one or more advantages. For example, such direct control of control parameter D may avoid excessively long periods at low inductor voltage separation. Further, such direct control of control parameter D may minimize disadvantages associated with subharmonic instability as compared to peak/valley control of current I_{L}. Such direct control may also enable simple, deterministic generation of state sequences as compared to hysteretic control of current I_{L}.

Using digital control in system 500 may also enable non-linear calculations for trajectory generator 506, first feedforward block 508, second feedforward block 510, and gain adjustment block 516, and may minimize circuit area as compared to equivalent analog circuitry.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112 (f) unless the words “means for” or “step for” are explicitly used in the particular claim.

What is claimed is:

1. A control circuit for generating a control parameter that defines a state sequence of a power converter, comprising:
a loop filter configured to, based on an error signal between a reference current signal and a feedback current measurement signal, correct for unmodeled errors in the feedback current measurement signal to generate the control parameter; and
a first feedforward block configured to generate a first offset to the control parameter based on a slew rate of the reference current signal.

2. The control circuit of claim 1, wherein the first feedforward block generates the first offset based on the slew rate and an absolute value of the reference current signal.

3. The control circuit of claim 1, wherein the first feedforward block generates the first offset based on the slew rate, an absolute value of the reference current signal, implied changes to a state of the power converter, and current values of the state of the power converter.

4. The control circuit of claim 1, further comprising a second feedforward block configured to generate a second offset to the control parameter based on an input voltage to and an output voltage from the power converter.

5. The control circuit of claim 1, further comprising a trajectory generator that generates the reference current signal based on a target current signal and the control parameter.

6. The control circuit of claim 1, further comprising a feedforward correction block configured to generate a second offset to the error signal to compensate for an expected error introduced by the first offset.

7. The control circuit of claim 1, further comprising a gain adjustment block configured to scale the control parameter based on an inverse of an input voltage to the power converter.

8. The control circuit of claim 1, further comprising a measurement block configured to estimate the feedback current measurement signal.

9. The control circuit of claim 8, further comprising an averaging block to average the feedback current measurement signal.

10. A method for generating a control parameter that defines a state sequence of a power converter, comprising:
based on an error signal between a reference current signal and a feedback current measurement signal, correcting with a loop filter for unmodeled errors in the feedback current measurement signal to generate the control parameter; and
generating with a first feedforward block a first offset to the control parameter based on a slew rate of the reference current signal.

11. The method of claim 10, further comprising generating the first offset based on the slew rate and an absolute value of the reference current signal.

12. The method of claim 10, further comprising generating the first offset based on the slew rate, an absolute value of the reference current signal, implied changes to a state of the power converter, and current values of the state of the power converter.

13. The method of claim 10, further comprising generating a second offset to the control parameter, with a second feedforward block, based on an input voltage to and an output voltage from the power converter.

14. The method of claim 10, further comprising generating the reference current signal based on a target current signal and the control parameter.

15. The method of claim 10, further comprising generating, with a feedforward correction block, a second offset to the error signal to compensate for an expected error introduced by the first offset.

16. The method of claim 10, further comprising scaling the control parameter based on an inverse of an input voltage to the power converter.

17. The method of claim 10, further comprising estimating the feedback current measurement signal with a measurement block.

18. The method of claim 17, further comprising averaging the feedback current measurement signal.
